(19) United States
(12) Patent Application Publication
(10) Pub. No.: US 2026/0179534 A1
(43) Pub. Date: Jun. 25, 2026

(54) GATE DRIVER, DISPLAY DEVICE INCLUDING THE GATE DRIVER, AND ELECTRONIC APPARATUS INCLUDING THE DISPLAY DEVICE

(71) Applicant: Samsung Display Co., Ltd., Yongin-Si (KR)

(72) Inventors: YOUNGWAN SEO, Yongin-si (KR); JUNKI JEONG, Yongin-si (KR); Jongyeop An, Yongin-si (KR)

(21) Appl. No.: 19/347,715

(22) Filed: Oct. 2, 2025

(30) Foreign Application Priority Data
Dec. 20, 2024 (KR) 10-2024-0192158

(51) Int. Cl. G09G 3/32

(52) U.S. Cl. CPC G09G 3/32; G09G 2300/0814; G09G 2300/0819; G09G 2310/0267; G09G 2310/0291

(57) ABSTRACT

A gate driver includes stages. Each of the stages includes a first logic circuit configured to control a signal of a first control node and a signal of a second control node based on a previous emission signal and an emission clock signal, a first buffer circuit configured to output an emission signal based on the signal of the first control node and the signal of the second control node, a second logic circuit configured to control a signal of a third control node based on a previous gate signal and the signal of the first control node, and a second buffer circuit configured to output a first gate signal based on the signal of the first control node and the signal of the third control node.

### CROSS-REFERENCE TO RELATED APPLICATION(S)

This application claims priority under 35 USC § 119 to Korean Patent Application No. 10-2024-0192158 filed on December 20, 2024, in the Korean Intellectual Property Office (KIPO), the entire disclosure of which is incorporated by reference herein.

### BACKGROUND

### 1. Field

Embodiments relate to a display device. More particularly, embodiments relate to a display device that displays an image, a gate driver included in the display device, and an electronic apparatus including the display device.

### 2. Description of the Related Art

A display device may include a display panel and gate drivers. The display panel may include pixels positioned in a display area. The gate drivers may be positioned in a non-display area, and may generate gate signals provided to each of the pixels.

The display device may include a number of gate drivers corresponding to the number of gate signals provided to the pixel. When the number of the gate drivers increases, because the gate drivers are positioned in the non-display area, a dead space of the display device may increase.

### SUMMARY

Embodiments provide a gate driver with a reduced area.

Embodiments provide a display device with a reduced dead space and an electronic apparatus including the display device.

In a gate driver including a plurality of stages according to embodiments, each of the stages includes a first logic circuit configured to control a signal of a first control node and a signal of a second control node based on a previous emission signal and an emission clock signal, a first buffer circuit configured to output an emission signal based on the signal of the first control node and the signal of the second control node, a second logic circuit configured to control a signal of a third control node based on a previous gate signal and the signal of the first control node, and a second buffer circuit configured to output a first gate signal based on the signal of the first control node and the signal of the third control node.

In an embodiment, a pulse of the first gate signal having an activation level may be output within a period in which the emission signal has a deactivation level.

In an embodiment, the first logic circuit may include a first transistor configured to transmit the previous emission signal to the first control node in response to the emission clock signal, a second transistor configured to transmit a first gate voltage to an intermediate node in response to the previous emission signal, a third transistor configured to transmit the emission clock signal to the second control node in response to a signal of the intermediate node, a fourth transistor configured to transmit the first gate voltage to the second control node in response to the signal of the first control node, a first capacitor connected between a line configured to transmit the first gate voltage and the second control node, and a second capacitor connected between a line configured to transmit the emission clock signal and the intermediate node.

In an embodiment, the first buffer circuit may include a fifth transistor configured to output a second gate voltage as the emission signal in response to the signal of the first control node, a sixth transistor configured to output the first gate voltage as the emission signal in response to the signal of the second control node, and a third capacitor connected between an emission output terminal configured to output the emission signal and a gate of the fifth transistor.

In an embodiment, each of the stages may include a fourteenth transistor connected between the first control node and the gate of the fifth transistor and the fourteenth transistor may stay turned on during operation.

In an embodiment, a level of the second gate voltage may be higher than a level of the first gate voltage.

In an embodiment, transistors included in each of the stages may be NMOS transistors.

In an embodiment, a level of the second gate voltage may be lower than a level of the first gate voltage.

In an embodiment, transistors included in each of the stages may be PMOS transistors.

In an embodiment, the second logic circuit may include a seventh transistor configured to connect the second control node to the third control node in response to the previous gate signal, and an eighth transistor configured to transmit the first gate voltage to the third control node in response to the signal of the first control node.

In an embodiment, the second logic circuit may further include a ninth transistor configured to transmit the first gate voltage to the third control node in response to a subsequent gate signal.

In an embodiment, the second buffer circuit may include a tenth transistor configured to output the first gate voltage as the first gate signal in response to the signal of the first control node, an eleventh transistor configured to output a first gate clock signal as the first gate signal in response to the signal of the third control node, and a fourth capacitor connected between a first gate output terminal configured to output the first gate signal and a gate of the eleventh transistor.

In an embodiment, each of the stages may include a fifteenth transistor connected between the third control node and the gate of the eleventh transistor and the fifteenth transistor may stay turned on during operation.

In an embodiment, each of the stages may include a third buffer circuit configured to output a second gate signal based on the signal of the first control node and the signal of the third control node.

In an embodiment, the third buffer circuit may include a twelfth transistor configured to output the first gate voltage as the second gate signal in response to the signal of the first control node, a thirteenth transistor configured to output a second gate clock signal as the second gate signal in response to the signal of the third control node, and a fifth capacitor connected between a second gate output terminal configured to output the second gate signal and a gate of the thirteenth transistor.

A display device according to embodiments includes a display panel including pixels, and a gate driver comprising a plurality of stages configured to provide a plurality of emission signals and a plurality of gate signals to the pixels. Each of the stages includes a first logic circuit configured to control a signal of a first control node and a signal of a second control node based on a previous emission signal and an emission clock signal, a first buffer circuit configured to output an emission signal in the plurality of emission signals based on the signal of the first control node and the signal of the second control node, a second logic circuit configured to control a signal of a third control node based on a previous gate signal and the signal of the first control node, and a second buffer circuit configured to output a gate signal in the plurality of gate signals based on the signal of the first control node and the signal of the third control node.

In an embodiment, a pulse of the gate signal having an activation level may be output within a period in which the emission signal has a deactivation level.

In an embodiment, each of the pixels may include a light-emitting element including an anode and a cathode configured to receive a second power voltage, a first pixel transistor including a gate connected to a first node, a first terminal connected to a second node, and a second terminal connected to a third node, a second pixel transistor configured to transmit a data voltage to the first node in response to a write gate signal, a third pixel transistor configured to transmit a reference voltage to the first node in response to a reference gate signal, a fourth pixel transistor configured to transmit an initialization voltage to the anode of the light-emitting element in response to an initialization gate signal, a fifth pixel transistor configured to transmit a first power voltage to the second node in response to a first emission signal, a sixth pixel transistor configured to connect the third node to the anode of the light-emitting element in response to a second emission signal, a storage capacitor connected between the first node and the third node, and a hold capacitor connected between a line configured to transmit the first power voltage and the third node.

In an embodiment, the emission signal may be the second emission signal, and the gate signal may be the write gate signal.

An electronic apparatus according to embodiments includes a processor configured to generate image data, and a display device configured to display an image corresponding to the image data. The display device includes a display panel including pixels, and a gate driver comprising a plurality of stages configured to provide a plurality of emission signals and a plurality of gate signals to the pixels. Each of the stages includes a first logic circuit configured to control a signal of a first control node and a signal of a second control node based on a previous emission signal and an emission clock signal, a first buffer circuit configured to output an emission signal in the plurality of emission signals based on the signal of the first control node and the signal of the second control node, a second logic circuit configured to control a signal of a third control node based on a previous gate signal and the signal of the first control node, and a second buffer circuit configured to output a gate signal in the plurality of gate signals based on the signal of the first control node and the signal of the third control node.

One stage of the gate driver according to the embodiments outputs the emission signal and the gate signal, so that the area of the gate driver may be reduced.

In the display device and the electronic apparatus according to the embodiments, the display device includes the gate driver with the reduced area, so that the dead space of the display device may be reduced.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating a gate driver according to an embodiment.

FIG. 2 is a circuit diagram illustrating an example of a stage of FIG. 1.

FIG. 3 is a waveform diagram illustrating signals of the stage of FIG. 2.

FIG. 4 is a circuit diagram illustrating an example of the stage of FIG. 1.

FIG. 5 is a block diagram illustrating a gate driver according to an embodiment.

FIG. 6 is a circuit diagram illustrating an example of a stage of FIG. 5.

FIG. 7 is a block diagram illustrating a display device according to an embodiment.

FIG. 8 is a circuit diagram illustrating a pixel of FIG. 7.

FIG. 9 is a waveform diagram illustrating signals of the pixel of FIG. 8.

FIG. 10 is a block diagram illustrating an electronic apparatus according to an embodiment.

### DETAILED DESCRIPTION OF THE EMBODIMENTS

Hereinafter, a gate driver, a display device, and an electronic apparatus according to embodiments of the present disclosure will be described in more detail with reference to the accompanying drawings. The same or similar reference numerals will be used for the same elements in the accompanying drawings.

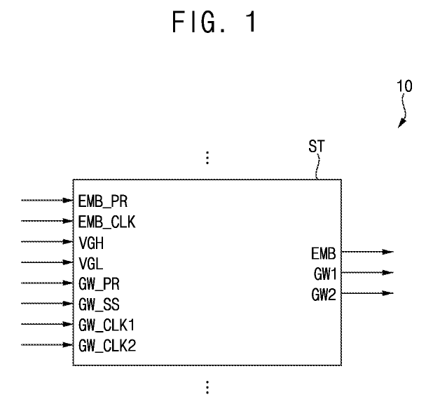

FIG. 1 is a block diagram illustrating a gate driver 10 according to an embodiment.

Referring to FIG. 1, the gate driver 10 may include a plurality of stages ST.

Each of the stages ST may receive an emission clock signal EMB_CLK, a high gate voltage VGH, a low gate voltage VGL, a subsequent gate signal GW_SS, a first gate clock signal GW_CLK1, and a second gate clock signal GW_CLK2. Each of the stages ST may output an emission signal EMB, a first gate signal GW1, and a second gate signal GW2.

The high gate voltage VGH may have an activation level of an n-channel metal oxide semiconductor (NMOS) transistor, and may have a deactivation level of a p-channel metal oxide semiconductor (PMOS) transistor. The low gate voltage VGL may have a deactivation level of the NMOS transistor, and may have an activation level of the PMOS transistor.

In an embodiment, the subsequent gate signal GW_SS received by an n^{th} stage may be the second gate signal GW2 output from an n+1^{th} stage.

In an embodiment, the first gate clock signal GW_CLK1 may be a signal obtained by shifting the emission clock signal EMB_CLK by 1/4 cycle of the emission clock signal EMB_CLK. In an embodiment, the second gate clock signal GW_CLK2 may be a signal obtained by shifting the first gate clock signal GW_CLK1 by 1/4 cycle of the first gate clock signal GW_CLK1.

A first stage among the stages ST may receive an emission start signal and a gate start signal, and stages other than the first stage among the stages ST may receive a previous emission signal EMB_PR and a previous gate signal GW_PR. In an embodiment, the previous emission signal EMB_PR received by the n^{th} stage may be the emission signal EMB output from an n-1^{th} stage. In an embodiment, the previous gate signal GW_PR received by the n^{th} stage may be the second gate signal GW2 output from the n-1^{th} stage.

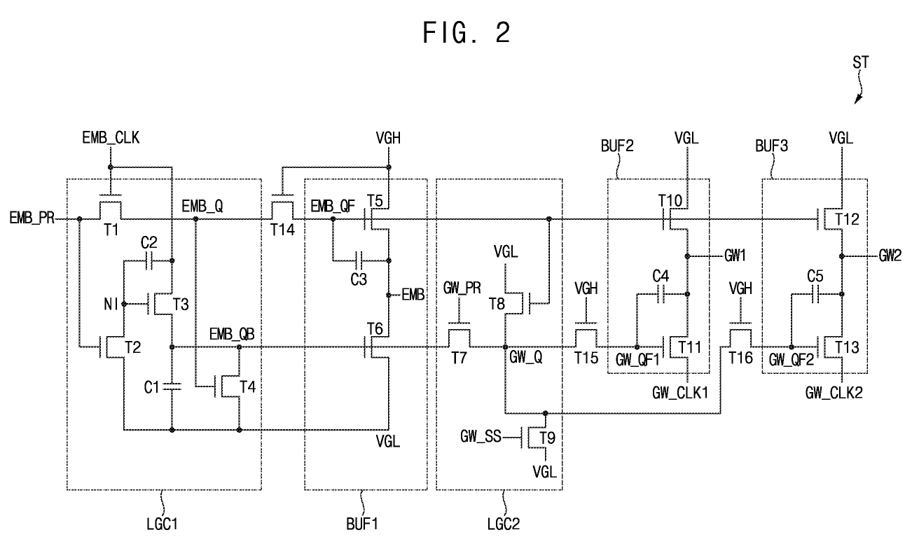

FIG. 2 is a circuit diagram illustrating an example of the stage ST of FIG. 1.

Referring to FIG. 2, the stage ST may include a first logic circuit LGC1, a first buffer circuit BUF1, a second logic circuit LGC2, a second buffer circuit BUF2, and a third buffer circuit BUF3.

The first logic circuit LGC1 may control a signal of a first control node EMB_Q and a signal of a second control node EMB_QB based on the previous emission signal EMB_PR and the emission clock signal EMB_CLK. The first logic circuit LGC1 may include a first transistor T1, a second transistor T2, a third transistor T3, a fourth transistor T4, a first capacitor C1, and a second capacitor C2.

The first transistor T1 may transmit the previous emission signal EMB_PR to the first control node EMB_Q in response to the emission clock signal EMB_CLK. The first transistor T1 may include a gate that receives the emission clock signal EMB_CLK, a first terminal that receives the previous emission signal EMB_PR, and a second terminal connected to the first control node EMB_Q.

The second transistor T2 may transmit a first gate voltage to an intermediate node NI in response to the previous emission signal EMB_PR. The second transistor T2 may include a gate that receives the previous emission signal EMB_PR, a first terminal that receives the first gate voltage, and a second terminal connected to the intermediate node NI.

The first gate voltage may be the low gate voltage VGL.

The third transistor T3 may transmit the emission clock signal EMB_CLK to the second control node EMB_QB in response to a signal of the intermediate node NI. The third transistor T3 may include a gate connected to the intermediate node NI, a first terminal that receives the emission clock signal EMB_CLK, and a second terminal connected to the second control node EMB_QB.

The fourth transistor T4 may transmit the first gate voltage to the second control node EMB_QB in response to a signal of the first control node EMB_Q. The fourth transistor T4 may include a gate connected to the first control node EMB_Q, a first terminal that receives the first gate voltage, and a second terminal connected to the second control node EMB_QB.

The first capacitor C1 may be connected between a line that transmits the first gate voltage and the second control node EMB_QB. The first capacitor C1 may include a first terminal that receives the first gate voltage and a second terminal connected to the second control node EMB_QB. The first capacitor C1 may store a signal of the second control node EMB_QB.

The second capacitor C2 may be connected between a line that transmits the emission clock signal EMB_CLK and the intermediate node NI. The second capacitor C2 may include a first terminal that receives the emission clock signal EMB_CLK and a second terminal connected to the intermediate node NI. A change in the emission clock signal EMB_CLK may be transmitted to the intermediate node NI by coupling effect of the second capacitor C2.

The first buffer circuit BUF1 may output the emission signal EMB based on the signal of the first control node EMB_Q and the signal of the second control node EMB_QB. The first buffer circuit BUF1 may include a fifth transistor T5, a sixth transistor T6, and a third capacitor C3.

The fifth transistor T5 may output a second gate voltage as the emission signal EMB in response to the signal of the first control node EMB_Q. The fifth transistor T5 may include a gate connected to a first-first control node EMB_QF, a first terminal that receives the second gate voltage, and a second terminal connected to an emission output terminal which outputs the emission signal EMB.

A voltage level of the second gate voltage may be higher than a voltage level of the first gate voltage. The second gate voltage may be the high gate voltage VGH.

The sixth transistor T6 may output the first gate voltage as the emission signal EMB in response to the signal of the second control node EMB_QB. The sixth transistor T6 may include a gate connected to the second control node EMB_QB, a first terminal that receives the first gate voltage, and a second terminal connected to the emission output terminal.

The third capacitor C3 may be connected between the emission output terminal and the gate of the fifth transistor T5. The third capacitor C3 may include a first terminal connected to the emission output terminal and a second terminal connected to the first-first control node EMB_QF. A change in the emission signal EMB may be transmitted to the first-first control node EMB_QF by coupling effect of the third capacitor C3.

The second logic circuit LGC2 may control a signal of a third control node GW_Q based on the previous gate signal GW_PR and the signal of the first control node EMB_Q. The second logic circuit LGC2 may include a seventh transistor T7, an eighth transistor T8, and a ninth transistor T9.

The seventh transistor T7 may connect the second control node EMB_QB to the third control node GW_Q in response to the previous gate signal GW_PR. The seventh transistor T7 may include a gate that receives the previous gate signal GW_PR, a first terminal connected to the second control node EMB_QB, and a second terminal connected to the third control node GW_Q.

The eighth transistor T8 may transmit the first gate voltage to the third control node GW_Q in response to the signal of the first control node EMB_Q. The eighth transistor T8 may include a gate connected to the first-first control node EMB_QF, a first terminal that receives the first gate voltage, and a second terminal connected to the third control node GW_Q.

The ninth transistor T9 may transmit the first gate voltage to the third control node GW_Q in response to the subsequent gate signal GW_SS. The ninth transistor T9 may include a gate that receives the subsequent gate signal GW_SS, a first terminal that receives the first gate voltage, and a second terminal connected to the third control node GW_Q.

The second buffer circuit BUF2 may output the first gate signal GW1 based on the signal of the first control node EMB_Q and the signal of the third control node GW_Q. The second buffer circuit BUF2 may include a tenth transistor T10, an eleventh transistor T11, and a fourth capacitor C4.

The tenth transistor T10 may output the first gate voltage as the first gate signal GW1 in response to the signal of the first control node EMB_Q. The tenth transistor T10 may include a gate connected to the first-first control node EMB_QF, a first terminal that receives the first gate voltage, and a second terminal connected to a first gate output terminal which outputs the first gate signal GW1.

The eleventh transistor T11 may output the first gate clock signal GW_CLK1 as the first gate signal GW1 in response to the signal of the third control node GW_Q. The eleventh transistor T11 may include a gate connected to a third-first control node GW_QF1, a first terminal that receives the first gate clock signal GW_CLK1, and a second terminal connected to the first gate output terminal.

The fourth capacitor C4 may be connected between the first gate output terminal and the gate of the eleventh transistor T11. The fourth capacitor C4 may include a first terminal connected to the first gate output terminal and a second terminal connected to the third-first control node GW_QF1. A change in the first gate signal GW1 may be transmitted to the third-first control node GW_QF1 by coupling effect of the fourth capacitor C4.

The third buffer circuit BUF3 may output the second gate signal GW2 based on the signal of the first control node EMB_Q and the signal of the third control node GW_Q. The third buffer circuit BUF3 may include a twelfth transistor T12, a thirteenth transistor T13, and a fifth capacitor C5.

The twelfth transistor T12 may output the first gate voltage as the second gate signal GW2 in response to the signal of the first control node EMB_Q. The twelfth transistor T12 may include a gate connected to the first-first control node EMB_QF, a first terminal that receives the first gate voltage, and a second terminal connected to a second gate output terminal which outputs the second gate signal GW2.

The thirteenth transistor T13 may output the second gate clock signal GW_CLK2 as the second gate signal GW2 in response to the signal of the third control node GW_Q. The thirteenth transistor T13 may include a gate connected to a third-second control node GW_QF2, a first terminal that receives the second gate clock signal GW_CLK2, and a second terminal connected to the second gate output terminal.

The fifth capacitor C5 may be connected between the second gate output terminal and the gate of the thirteenth transistor T13. The fifth capacitor C5 may include a first terminal connected to the second gate output terminal and a second terminal connected to the third-second control node GW_QF2. A change in the second gate signal GW2 may be transmitted to the third-second control node GW_QF2 by coupling effect of the fifth capacitor C5.

In an embodiment, the stage ST may further include a fourteenth transistor T14, a fifteenth transistor T15, and a sixteenth transistor T16.

The fourteenth transistor T14 may be connected between the first control node EMB_Q and the gate of the fifth transistor T5, and the fourteenth transistor T14 may stay turned on during operation. The fourteenth transistor T14 may include a gate that receives the second gate voltage, a first terminal connected to the first control node EMB_Q, and a second terminal connected to the first-first control node EMB_QF. The fourteenth transistor T14 may stabilize the signal of the first control node EMB_Q. Even if the signal of the first-first control node EMB_QF is boosted by the coupling effect of the third capacitor C3, the signal of the first control node EMB_Q may be boosted less than the signal of the first-first control node EMB_QF by the fourteenth transistor T14.

The fifteenth transistor T15 may be connected between the third control node GW_Q and the gate of the eleventh transistor T11, and may stay turned on during operation. The fifteenth transistor T15 may include a gate that receives the second gate voltage, a first terminal connected to the third control node GW_Q, and a second terminal connected to the third-first control node GW_QF1. The fifteenth transistor T15 may stabilize the signal of the third control node GW_Q. Even if the signal of the third-first control node GW_QF1 is boosted by the coupling effect of the fourth capacitor C4, the signal of the third control node GW_Q may be boosted less than the signal of the third-first control node GW_QF1 by the fifteenth transistor T15.

The sixteenth transistor T16 may be connected between the third control node GW_Q and the gate of the thirteenth transistor T13, and may stay turned on during operation. The sixteenth transistor T16 may include a gate that receives the second gate voltage, a first terminal connected to the third control node GW_Q, and a second terminal connected to the third-second control node GW_QF2. The sixteenth transistor T16 may stabilize the signal of the third control node GW_Q. Even if the signal of the third-second control node GW_QF2 is boosted by the coupling effect of the fifth capacitor C5, the signal of the third control node GW_Q may be boosted less than the signal of the third-second control node GW_QF2 by the sixteenth transistor T16.

The transistors included in the stage ST may be NMOS transistors. In other words, each of the first transistor T1, the second transistor T2, the third transistor T3, the fourth transistor T4, the fifth transistor T5, the sixth transistor T6, the seventh transistor T7, the eighth transistor T8, the ninth transistor T9, the tenth transistor T10, the eleventh transistor T11, the twelfth transistor T12, the thirteenth transistor T13, the fourteenth transistor T14, the fifteenth transistor T15, and the sixteenth transistor T16 may be an NMOS transistor.

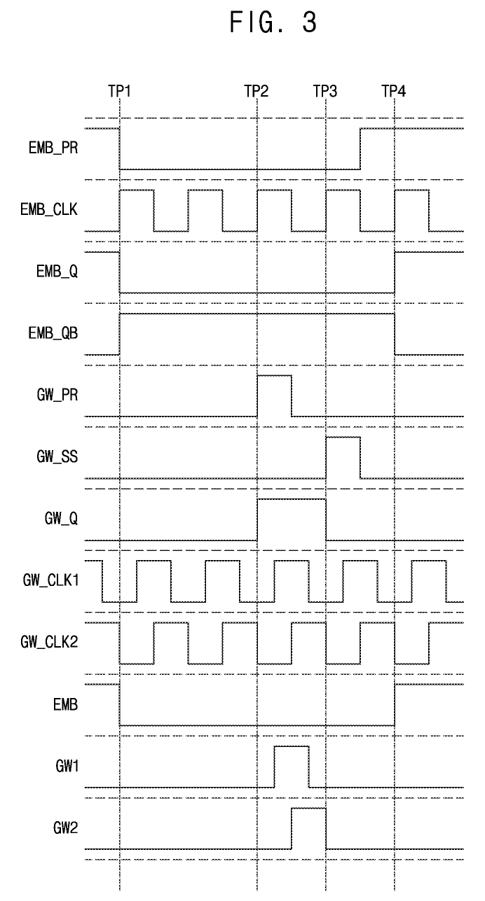

FIG. 3 is a waveform diagram illustrating signals of the stage ST of FIG. 2.

Referring to FIGS. 2 and 3, at a first time point TP1, the first transistor T1 is turned on so that the previous emission signal EMB_PR having a deactivation level may be transmitted to the first control node EMB_Q, and the third transistor T3 is turned on so that the emission clock signal EMB_CLK having an activation level may be transmitted to the second control node EMB_QB. The fifth transistor T5 is turned off and the sixth transistor T6 is turned on so that the emission signal EMB having a deactivation level may be output. The signal of the third control node GW_Q may be maintained at a deactivation level. The tenth transistor T10 and the eleventh transistor T11 are turned off so that the first gate signal GW1 may be maintained at a deactivation level. The twelfth transistor T12 and the thirteenth transistor T13 are turned off so that the second gate signal GW2 may be maintained at a deactivation level.

At a second time point TP2, the seventh transistor T7 is turned on so that the signal of the second control node EMB_QB having the activation level may be transmitted to the third control node GW_Q. The tenth transistor T10 is turned off and the eleventh transistor T11 is turned on so that the first gate clock signal GW_CLK1 may be output as the first gate signal GW1 in a period between the second time point TP2 and a third time point TP3. The twelfth transistor T12 is turned off and the thirteenth transistor T13 is turned on so that the second gate clock signal GW_CLK2 may be output as the second gate signal GW2 in the period between the second time point TP2 and the third time point TP3.

At the third time point TP3, the ninth transistor T9 is turned on so that the first gate voltage having the deactivation level may be transmitted to the third control node GW_Q. The tenth transistor T10 and the eleventh transistor T11 are turned off so that the first gate signal GW1 may be maintained at the deactivation level. The twelfth transistor T12 and the thirteenth transistor T13 are turned off so that the second gate signal GW2 may be maintained at the deactivation level.

At a fourth time point TP4, the first transistor T1 is turned on so that the previous emission signal EMB_PR having an activation level may be transmitted to the first control node EMB_Q, the second transistor T2 is turned on so that the first gate voltage having the deactivation level may be transmitted to the intermediate node NI, and the fourth transistor T4 is turned on so that the first gate voltage having the deactivation level may be transmitted to the second control node EMB_QB. The fifth transistor T5 is turned on and the sixth transistor T6 is turned off so that the emission signal EMB having an activation level may be output. The signal of the third control node GW_Q may be maintained at the deactivation level. The tenth transistor T10 is turned on and the eleventh transistor T11 is turned off so that the first gate signal GW1 may be maintained at the deactivation level. The twelfth transistor T12 is turned on and the thirteenth transistor T13 is turned off so that the second gate signal GW2 may be maintained at the deactivation level.

The emission signal EMB may have the deactivation level in a period between the first time point TP1 and the fourth time point TP4, and the pulse of the first gate signal GW1 having the activation level and the pulse of the second gate signal GW2 having the activation level may be positioned in the period between the second time point TP2 and the third time point TP3. Accordingly, the pulse of the first gate signal GW1 having the activation level and the pulse of the second gate signal GW2 having the activation level may be output within a period in which the emission signal EMB has the deactivation level.

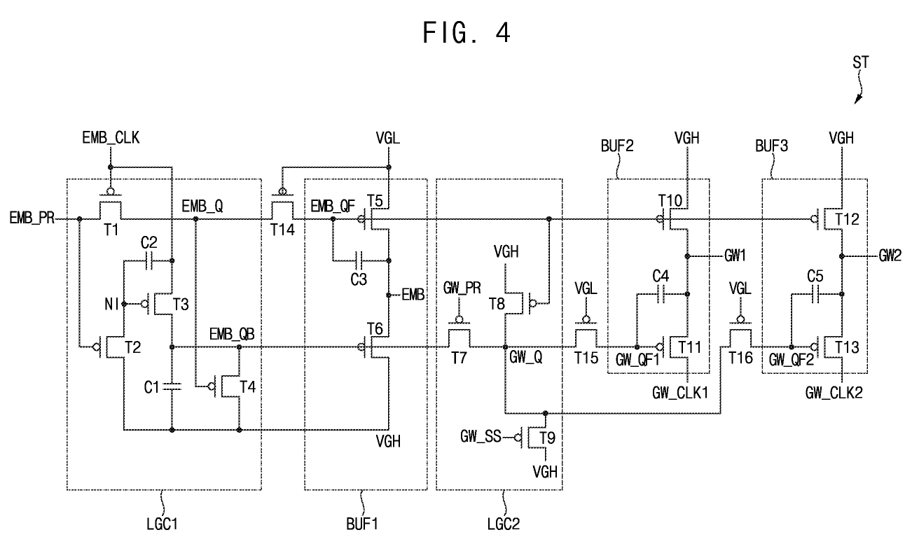

FIG. 4 is a circuit diagram illustrating an example of the stage ST of FIG. 1.

Referring to FIG. 4, the stage ST may include a first logic circuit LGC1, a first buffer circuit BUF1, a second logic circuit LGC2, a second buffer circuit BUF2, and a third buffer circuit BUF3. Descriptions of components of the stage ST described with reference to FIG. 4, which are substantially the same as or similar to those of the stage ST described with reference to FIG. 2, are omitted.

The first gate voltage may be the high gate voltage VGH. The voltage level of the second gate voltage may be lower than the voltage level of the first gate voltage. The second gate voltage may be the low gate voltage VGL.

The transistors included in the stage ST may be PMOS transistors. In other words, each of the first transistor T1, the second transistor T2, the third transistor T3, the fourth transistor T4, the fifth transistor T5, the sixth transistor T6, the seventh transistor T7, the eighth transistor T8, the ninth transistor T9, the tenth transistor T10, the eleventh transistor T11, the twelfth transistor T12, the thirteenth transistor T13, the fourteenth transistor T14, the fifteenth transistor T15, and the sixteenth transistor T16 may be a PMOS transistor.

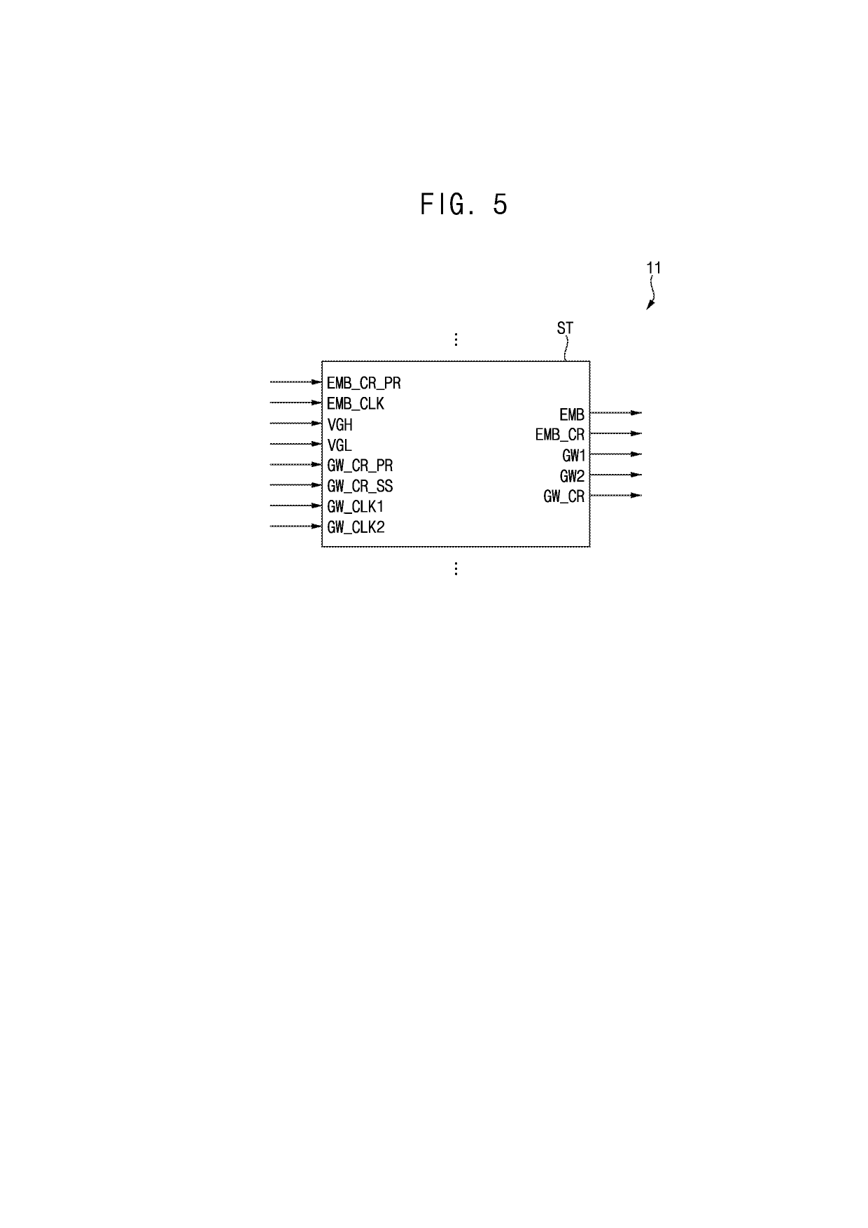

FIG. 5 is a block diagram illustrating a gate driver 11 according to an embodiment.

Referring to FIG. 5, the gate driver 11 may include a plurality of stages ST. Descriptions of components of the gate driver 11 described with reference to FIG. 5, which are substantially the same as or similar to those of the gate driver 10 described with reference to FIG. 1, are omitted.

Each of the stages ST may receive an emission clock signal EMB_CLK, a high gate voltage VGH, a low gate voltage VGL, a subsequent gate carry signal GW_CR_SS, a first gate clock signal GW_CLK1, and a second gate clock signal GW_CLK2. Each of the stages ST may output an emission signal EMB, an emission carry signal EMB_CR, a first gate signal GW1, a second gate signal GW2, and a gate carry signal GW_CR.

In an embodiment, the subsequent gate carry signal GW_CR_SS received by an n^{th} stage may be the gate carry signal GW_CR output from an n+1^{th} stage.

The stages ST except for the first stage may receive a previous emission carry signal EMB_CR_PR and a previous gate carry signal GW_CR_PR. In an embodiment, the previous emission carry signal EMB_CR_PR received by the n^{th} stage may be the emission carry signal EMB_CR output from an n-1^{th} stage. In an embodiment, the previous gate carry signal GW_CR_PR received by the n^{th} stage may be the gate carry signal GW_CR output from the n-1^{th} stage.

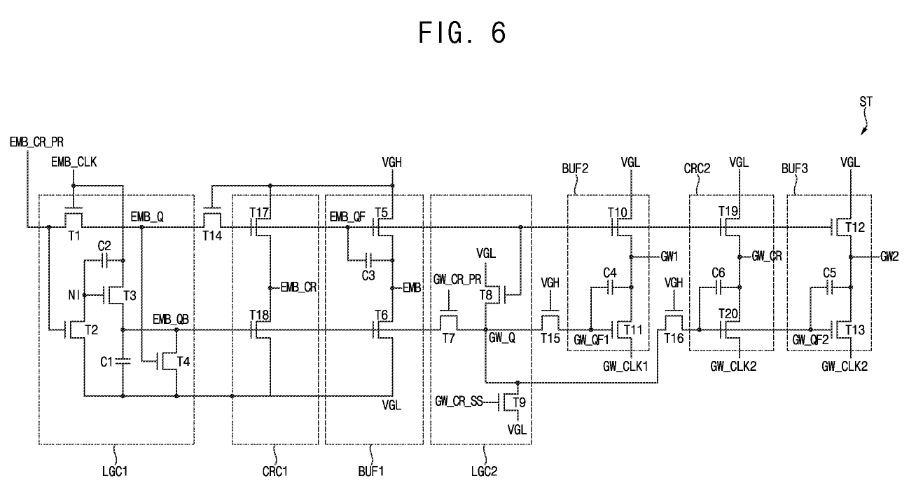

FIG. 6 is a circuit diagram illustrating an example of the stage ST of FIG. 5.

Referring to FIG. 6, the stage ST may include a first logic circuit LGC1, a first buffer circuit BUF1, a second logic circuit LGC2, a second buffer circuit BUF2, a third buffer circuit BUF3, a first carry circuit CRC1, and a second carry circuit CRC2. Descriptions of components of the stage ST described with reference to FIG. 6, which are substantially the same as or similar to those of the stage ST described with reference to FIG. 2, are omitted.

The first logic circuit LGC1 may control the signal of the first control node EMB_Q and the signal of the second control node EMB_QB based on the previous emission carry signal EMB_CR_PR and the emission clock signal EMB_CLK.

The first transistor T1 may transmit the previous emission carry signal EMB_CR_PR to the first control node EMB_Q in response to the emission clock signal EMB_CLK. The first transistor T1 may include a gate that receives the previous emission carry signal EMB_CR_PR, a first terminal that receives the previous emission signal EMB_PR, and a second terminal connected to the first control node EMB_Q.

The second transistor T2 may transmit the first gate voltage to the intermediate node NI in response to the previous emission carry signal EMB_CR_PR. The second transistor T2 may include a gate that receives the previous emission carry signal EMB_CR_PR, a first terminal that receives the first gate voltage, and a second terminal connected to the intermediate node NI.

The second logic circuit LGC2 may control the signal of the third control node GW_Q based on the previous gate carry signal GW_CR_PR and the signal of the first control node EMB_Q.

The seventh transistor T7 may connect the second control node EMB_QB to the third control node GW_Q in response to the previous gate carry signal GW_CR_PR. The seventh transistor T7 may include a gate that receives the previous gate carry signal GW_CR_PR, a first terminal connected to the second control node EMB_QB, and a second terminal connected to the third control node GW_Q.

The ninth transistor T9 may transmit the first gate voltage to the third control node GW_Q in response to the subsequent gate carry signal GW_CR_SS. The ninth transistor T9 may include a gate that receives the subsequent gate carry signal GW_CR_SS, a first terminal that receives the first gate voltage, and a second terminal connected to the third control node GW_Q.

The first carry circuit CRC1 may output the emission carry signal EMB_CR based on the signal of the first control node EMB_Q and the signal of the second control node EMB_QB. The first carry circuit CRC1 may include a seventeenth transistor T17 and an eighteenth transistor T18.

The seventeenth transistor T17 may output the second gate voltage as the emission carry signal EMB_CR in response to the signal of the first control node EMB_Q. The seventeenth transistor T17 may include a gate connected to the first-first control node EMB_QF, a first terminal that receives the second gate voltage, and a second terminal connected to an emission carry output terminal which outputs the emission carry signal EMB_CR.

The eighteenth transistor T18 may output the first gate voltage as the emission carry signal EMB_CR in response to the signal of the second control node EMB_QB. The eighteenth transistor T18 may include a gate connected to the second control node EMB_QB, a first terminal that receives the first gate voltage, and a second terminal connected to the emission carry output terminal.

The second carry circuit CRC3 may output the gate carry signal GW_CR based on the signal of the first control node EMB_Q and the signal of the third control node GW_Q. The second carry circuit CRC3 may include a nineteenth transistor T19, a twentieth transistor T20, and a sixth capacitor C6.

The nineteenth transistor T19 may output the first gate voltage as the gate carry signal GW_CR in response to the signal of the first control node EMB_Q. The nineteenth transistor T19 may include a gate connected to the first-first control node EMB_QF, a first terminal that receives the first gate voltage, and a second terminal connected to a gate carry output terminal which outputs the gate carry signal GW_CR.

The twentieth transistor T20 may output the second gate clock signal GW_CLK2 as the gate carry signal GW_CR in response to the signal of the third control node GW_Q. The twentieth transistor T20 may include a gate connected to the third-second control node GW_QF2, a first terminal that receives the second gate clock signal GW_CLK2, and a second terminal connected to the gate carry output terminal.

The sixth capacitor C6 may be connected between the gate carry output terminal and the gate of the twentieth transistor T20. The sixth capacitor C6 may include a first terminal connected to the gate carry output terminal and a second terminal connected to the third-second control node GW_QF2.

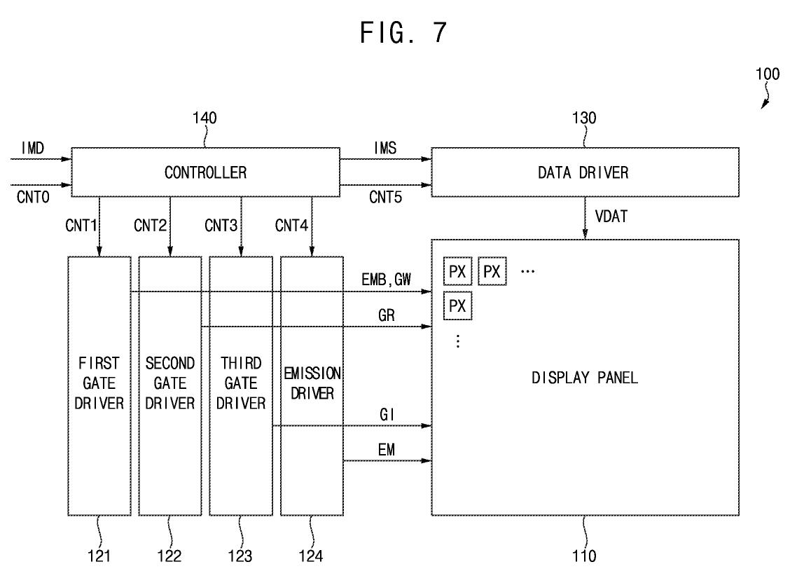

FIG. 7 is a block diagram illustrating a display device 100 according to an embodiment.

Referring to FIG. 7, the display device 100 may include a display panel 110, a first gate driver 121, a second gate driver 122, a third gate driver 123, an emission driver 124, a data driver 130, and a controller 140.

The display panel 110 may include pixels PX.

The first gate driver 121 may provide second emission signals EMB and write gate signals GW to the pixels PX. The first gate driver 121 may generate the second emission signals EMB and the write gate signals GW based on a first control signal CNT1. The first control signal CNT1 may include a second emission start signal, a second emission clock signal, a write gate start signal, a write gate clock signal, etc.

The second gate driver 122 may provide reference gate signals GR to the pixels PX. The second gate driver 122 may generate the reference gate signals GR based on a second control signal CNT2. The second control signal CNT2 may include a reference gate start signal, a reference gate clock signal, etc.

The third gate driver 123 may provide initialization gate signals GI to the pixels PX. The third gate driver 123 may generate the initialization gate signals GI based on a third control signal CNT3. The third control signal CNT3 may include an initialization gate start signal, an initialization gate clock signal, etc.

The emission driver 124 may provide first emission signals EM to the pixels PX. The emission driver 124 may generate the first emission signals EM based on a fourth control signal CNT4. The fourth control signal CNT4 may include a first emission start signal, a first emission clock signal, etc.

The data driver 130 may provide data voltages VDAT to the pixels PX. The data driver 130 may generate the data voltages VDAT based on an image signal IMS and a fifth control signal CNT5. The data driver 130 may convert the image signal IMS in digital format into the data voltages VDAT in analog format. The fifth control signal CNT5 may include a load signal, a data clock signal, etc.

The controller 140 may control operation (or driving) of the first gate driver 121, operation (or driving) of the second gate driver 122, operation (or driving) of the third gate driver 123, operation (or driving) of the emission driver 124, and operation (or driving) of the data driver 130. The controller 140 may provide the first control signal CNT1 to the first gate driver 121, may provide the second control signal CNT2 to the second gate driver 122, may provide the third control signal CNT3 to the third gate driver 123, may provide the fourth control signal CNT4 to the emission driver 124, and may provide the image signal IMS and the fifth control signal CNT5 to the data driver 130. The controller 140 may generate the image signal IMS based on image data IMD, and may generate the first control signal CNT1, the second control signal CNT2, the third control signal CNT3, the fourth control signal CNT4, and the fifth control signal CNT5 based on a controller control signal CNT0. The controller control signal CNT0 may include a horizontal synchronization signal, a vertical synchronization signal, a master clock signal, a data enable signal, etc.

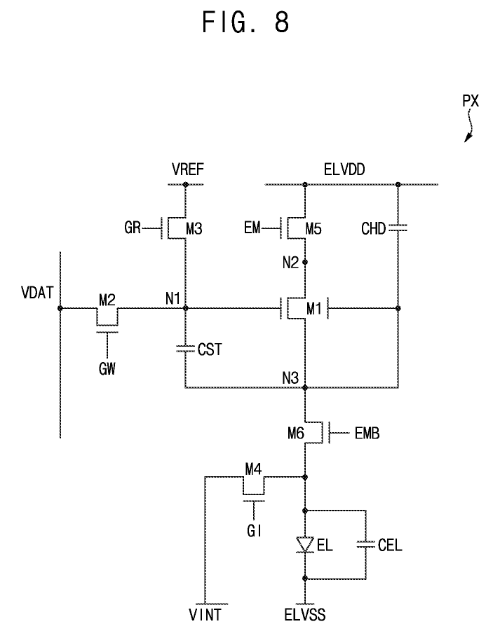

FIG. 8 is a circuit diagram illustrating the pixel PX of FIG. 7.

Referring to FIG. 8, the pixel PX may receive a first emission signal EM, a second emission signal EMB, a reference gate signal GR, an initialization gate signal GI, a write gate signal GW, a data voltage VDAT, a reference voltage VREF, an initialization voltage VINT, a first power voltage ELVDD, and a second power voltage ELVSS. In an embodiment, a voltage level of the initialization voltage VINT may be lower than a voltage level of the second power voltage ELVSS. In an embodiment, a voltage level of the first power voltage ELVDD may be higher than a voltage level of the second power voltage ELVSS.

In an embodiment, the emission signal EMB of FIG. 2 and the emission signal EMB of FIG. 6 may be the second emission signal EMB of FIG. 8. In an embodiment, the first gate signal GW1 or the second gate signal GW2 of FIG. 2 and the first gate signal GW1 or the second gate signal GW2 of FIG. 6 may be the write gate signal GW of FIG. 8.

The pixel PX may include a light-emitting element EL, a first pixel transistor M1, a second pixel transistor M2, a third pixel transistor M3, a fourth pixel transistor M4, a fifth pixel transistor M5, a sixth pixel transistor M6, a storage capacitor CST, and a hold capacitor CHD.

The light-emitting element EL may be connected between a line that transmits the first power voltage ELVDD and a line that transmits the second power voltage ELVSS. The light-emitting element EL may include an anode and a cathode that receives the second power voltage ELVSS. The light-emitting element EL may emit light with a luminance corresponding to a driving current. In an embodiment, the light emitting element EL may be an organic light emitting diode, an inorganic light emitting diode, a micro light emitting diode, a nano light emitting diode, a quantum dot light emitting diode, etc.

The first pixel transistor M1 may include a gate connected to a first node N1, a first terminal connected to a second node N2, and a second terminal connected to a third node N3. The first pixel transistor M1 may generate the driving current corresponding to a voltage difference between the first node N1 and the third node N3. In an embodiment, the first pixel transistor M1 may further include a body connected to the third node N3.

The second pixel transistor M2 may transmit the data voltage VDAT to the first node N1 in response to the write gate signal GW. The second pixel transistor M2 may include a gate that receives the write gate signal GW, a first terminal that receives the data voltage VDAT, and a second terminal connected to the first node N1.

The third pixel transistor M3 may transmit the reference voltage VREF to the first node N1 in response to the reference gate signal GR. The third pixel transistor M3 may include a gate that receives the reference gate signal GR, a first terminal that receives the reference voltage VREF, and a second terminal connected to the first node N1.

The fourth pixel transistor M4 may transmit the initialization voltage VINT to the anode of the light-emitting element EL in response to the initialization gate signal GI. The fourth pixel transistor M4 may include a gate that receives the initialization gate signal GI, a first terminal that receives the initialization voltage VINT, and a second terminal connected to the anode of the light-emitting element EL.

The fifth pixel transistor M5 may transmit the first power voltage ELVDD to the second node N2 in response to the first emission signal EM. The fifth pixel transistor M5 may include a gate that receives the first emission signal EM, a first terminal that receives the first power voltage ELVDD, and a second terminal connected to the second node N2.

The sixth pixel transistor M6 may connect the third node N3 to the anode of the light-emitting element EL in response to the second emission signal EMB. The sixth pixel transistor M6 may include a gate that receives the second emission signal EMB, a first terminal connected to the third node N3, and a second terminal connected to the anode of the light-emitting element EL.

The storage capacitor CST may be connected between the first node N1 and the third node N3. The storage capacitor CST may include a first terminal connected to the first node N1 and a second terminal connected to the third node N3.

The hold capacitor CHD may be connected between a line that transmits the first power voltage ELVDD and the third node N3. The hold capacitor CHD may include a first terminal that receives the first power voltage ELVDD and a second terminal connected to the third node N3.

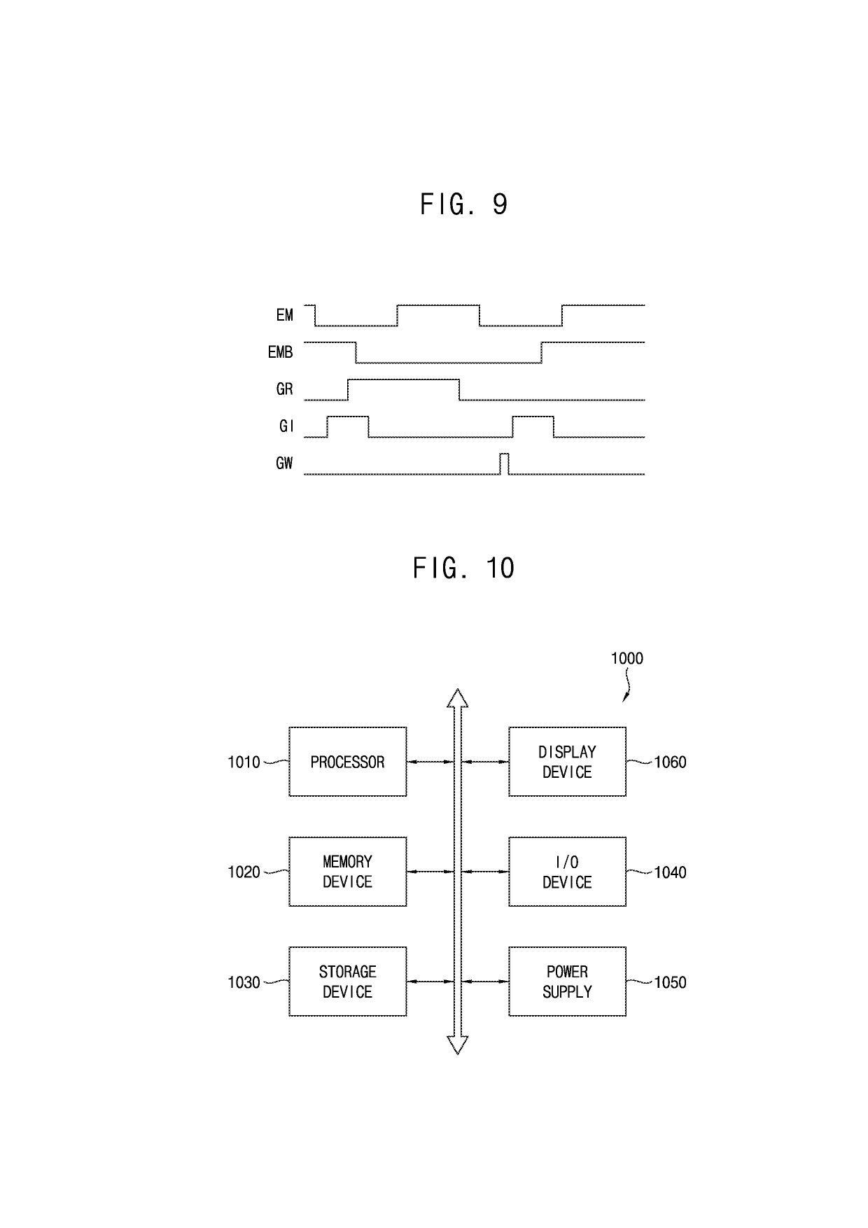

FIG. 9 is a waveform diagram illustrating signals of the pixel PX of FIG. 8.

Referring to FIGS. 8 and 9, in a period in which the initialization gate signal GI has an activation level, the fourth pixel transistor M4 is turned on so that the initialization voltage VINT may be transmitted to the anode of the light-emitting element EL. Accordingly, the anode of the light-emitting element EL may be initialized. Further, charges stored in the anode of the light-emitting element EL by a parasitic capacitor CEL formed between the two terminals of the light-emitting element EL may be discharged to a line that transmits the initialization voltage VINT through the fourth pixel transistor M4.

In a period in which the reference gate signal GR has an activation level, the third pixel transistor M3 is turned on so that the reference voltage VREF may be transmitted to the gate of the first pixel transistor M1. Accordingly, the gate of the first pixel transistor M1 may be initialized.

In a period in which the reference gate signal GR and the first emission signal EM have an activation level, the third pixel transistor M3 and the fifth pixel transistor M5 are turned on so that a voltage corresponding to a threshold voltage of the first pixel transistor M1 may be stored in the storage capacitor CST. Accordingly, the threshold voltage of the first pixel transistor M1 may be compensated.

In a period in which the write gate signal GW has an activation level, the second pixel transistor M2 is turned on so that the data voltage VDAT may be transmitted to the gate of the first pixel transistor M1. Accordingly, a voltage corresponding to the threshold voltage of the first pixel transistor M1 and the data voltage VDAT may be stored in the storage capacitor CST.

In a period in which the initialization gate signal GI has the activation level, the fourth pixel transistor M4 is turned on so that the initialization voltage VINT may be transmitted to the anode of the light-emitting element EL. Accordingly, the anode of the light-emitting element EL may be initialized.

In a period in which the first emission signal EM and the second emission signal EMB have an activation level, the fifth pixel transistor M5 and the sixth pixel transistor M6 are turned on so that the first pixel transistor M1 may generate the driving current corresponding to the data voltage VDAT, and the light-emitting element EL may emit light with a luminance corresponding to the driving current.

FIG. 10 is a block diagram illustrating an electronic apparatus 1000 according to an embodiment.

Referring to FIG. 10, the electronic apparatus 1000 may include a processor 1010, a memory device 1020, a storage device 1030, an input/output (I/O) device 1040, a power supply 1050, and a display device 1060. The electronic apparatus 1000 may further include a plurality of ports capable of communicating with a video card, a sound card, a memory card, a USB device, and the like, or communicating with other systems.

The processor 1010 may perform specific calculations or tasks. In an embodiment, the processor 1010 may be a microprocessor, a central processing unit (CPU), or the like. The processor 1010 may be connected to other components through an address bus, a control bus, a data bus, and the like. In an embodiment, the processor 1010 may also be connected to an expansion bus such as a peripheral component interconnect (PCI) bus. In an embodiment, the processor 1010 may provide the image data IMD of FIG. 7 and the controller control signal CNT0 of FIG. 7 to the display device 1060. The Processor 1010 may include one or more processors. The one or more processors may work individually, as a collective or as a subset of the collective. For example, two out of three processors may work together to execute operations for an application.

The memory device 1020 may store data for an operation of the electronic apparatus 1000. For example, the memory device 1020 may include: a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device such as a dynamic random access memory (DRAM), a static random access memory (SRAM), or a mobile DRAM.

The storage device 1030 may include a solid state drive (SSD), a hard disk drive (HDD), a CD-ROM, and the like. The I/O device 1040 may include: an input device such as a keyboard, a keypad, a touch pad, a touch screen, or a mouse; and an output device such as a speaker or a printer. The power supply 1050 may supply a power for the operation of the electronic apparatus 1000. The display device 1060 may be connected to other components through the buses or other communication links. The display device 1060 may correspond to the display device 100 of FIG. 7.

The display device according to the embodiments may be applied to a display device included in a computer, a notebook, a mobile phone, a smart phone, a smart pad, a smart watch, a PMP, a PDA, an MP3 player, or the like.

Although the gate driver, the display device, and the electronic apparatus according to the embodiments have been described with reference to the drawings, the illustrated embodiments are examples, and may be modified and changed by a person having ordinary knowledge in the relevant technical field without departing from the technical spirit described in the following claims.

What is claimed is:

1. A gate driver comprising a plurality of stages,
wherein each of the stages comprises:
a first logic circuit configured to control a signal of a first control node and a signal of a second control node based on a previous emission signal and an emission clock signal;
a first buffer circuit configured to output an emission signal based on the signal of the first control node and the signal of the second control node;
a second logic circuit configured to control a signal of a third control node based on a previous gate signal and the signal of the first control node; and
a second buffer circuit configured to output a first gate signal based on the signal of the first control node and the signal of the third control node.

2. The gate driver of claim 1, wherein a pulse of the first gate signal having an activation level is output within a period in which the emission signal has a deactivation level.

3. The gate driver of claim 1, wherein the first logic circuit includes:
a first transistor configured to transmit the previous emission signal to the first control node in response to the emission clock signal;
a second transistor configured to transmit a first gate voltage to an intermediate node in response to the previous emission signal;
a third transistor configured to transmit the emission clock signal to the second control node in response to a signal of the intermediate node;
a fourth transistor configured to transmit the first gate voltage to the second control node in response to the signal of the first control node;
a first capacitor connected between a line configured to transmit the first gate voltage and the second control node; and
a second capacitor connected between a line configured to transmit the emission clock signal and the intermediate node.

4. The gate driver of claim 3, wherein the first buffer circuit includes:
a fifth transistor configured to output a second gate voltage as the emission signal in response to the signal of the first control node;
a sixth transistor configured to output the first gate voltage as the emission signal in response to the signal of the second control node; and
a third capacitor connected between an emission output terminal configured to output the emission signal and a gate of the fifth transistor.

5. The gate driver of claim 4, wherein each of the stages comprises:
a fourteenth transistor connected between the first control node and the gate of the fifth transistor and the fourteenth transistor stays turned on during operation.

6. The gate driver of claim 4, wherein a level of the second gate voltage is higher than a level of the first gate voltage.

7. The gate driver of claim 6, wherein transistors included in each of the stages are NMOS transistors.

8. The gate driver of claim 4, wherein a level of the second gate voltage is lower than a level of the first gate voltage.

9. The gate driver of claim 8, wherein transistors included in each of the stages are PMOS transistors.

10. The gate driver of claim 3, wherein the second logic circuit includes:
a seventh transistor configured to connect the second control node to the third control node in response to the previous gate signal; and
an eighth transistor configured to transmit the first gate voltage to the third control node in response to the signal of the first control node.

11. The gate driver of claim 10, wherein the second logic circuit further includes:
a ninth transistor configured to transmit the first gate voltage to the third control node in response to a subsequent gate signal.

12. The gate driver of claim 10, wherein the second buffer circuit includes:
a tenth transistor configured to output the first gate voltage as the first gate signal in response to the signal of the first control node;
an eleventh transistor configured to output a first gate clock signal as the first gate signal in response to the signal of the third control node; and
a fourth capacitor connected between a first gate output terminal configured to output the first gate signal and a gate of the eleventh transistor.

13. The gate driver of claim 12, wherein each of the stages comprises:
a fifteenth transistor connected between the third control node and the gate of the eleventh transistor and the fifteenth transistor stays turned on during operation.

14. The gate driver of claim 10, wherein each of the stages comprises:
a third buffer circuit configured to output a second gate signal based on the signal of the first control node and the signal of the third control node.

15. The gate driver of claim 14, wherein the third buffer circuit includes:
a twelfth transistor configured to output the first gate voltage as the second gate signal in response to the signal of the first control node;
a thirteenth transistor configured to output a second gate clock signal as the second gate signal in response to the signal of the third control node; and
a fifth capacitor connected between a second gate output terminal configured to output the second gate signal and a gate of the thirteenth transistor.

16. A display device comprising:
a display panel including pixels; and
a gate driver comprising a plurality of stages configured to provide a plurality of emission signals and a plurality of gate signals to the pixels,
wherein each of the stages comprises:
a first logic circuit configured to control a signal of a first control node and a signal of a second control node based on a previous emission signal and an emission clock signal;
a first buffer circuit configured to output an emission signal in the plurality of emission signals based on the signal of the first control node and the signal of the second control node;
a second logic circuit configured to control a signal of a third control node based on a previous gate signal and the signal of the first control node; and
a second buffer circuit configured to output a gate signal in the plurality of gate signals based on the signal of the first control node and the signal of the third control node.

17. The display device of claim 16, wherein a pulse of the gate signal having an activation level is output within a period in which the emission signal has a deactivation level.

18. The display device of claim 16, wherein each of the pixels includes:
a light-emitting element including an anode and a cathode configured to receive a second power voltage;
a first pixel transistor including a gate connected to a first node, a first terminal connected to a second node, and a second terminal connected to a third node;
a second pixel transistor configured to transmit a data voltage to the first node in response to a write gate signal;
a third pixel transistor configured to transmit a reference voltage to the first node in response to a reference gate signal;
a fourth pixel transistor configured to transmit an initialization voltage to the anode of the light-emitting element in response to an initialization gate signal;
a fifth pixel transistor configured to transmit a first power voltage to the second node in response to a first emission signal;
a sixth pixel transistor configured to connect the third node to the anode of the light-emitting element in response to a second emission signal;
a storage capacitor connected between the first node and the third node; and
a hold capacitor connected between a line configured to transmit the first power voltage and the third node.

19. The display device of claim 18, wherein the emission signal is the second emission signal, and
wherein the gate signal is the write gate signal.

20. An electronic apparatus comprising:
a processor configured to generate image data; and
a display device configured to display an image corresponding to the image data, the display device comprising:
a display panel including pixels; and
a gate driver comprising a plurality of stages configured to provide a plurality of emission signals and a plurality of gate signals to the pixels,
wherein each of the stages comprises:
a first logic circuit configured to control a signal of a first control node and a signal of a second control node based on a previous emission signal and an emission clock signal;
a first buffer circuit configured to output an emission signal in the plurality of emission signals based on the signal of the first control node and the signal of the second control node;
a second logic circuit configured to control a signal of a third control node based on a previous gate signal and the signal of the first control node; and
a second buffer circuit configured to output a gate signal in the plurality of gate signals based on the signal of the first control node and the signal of the third control node.
